(19) United States
(12) Patent Application Publication
(10) Pub. No.: US 2025/0362065 A1
(43) Pub. Date: Nov. 27, 2025

(54) FLUID MANAGEMENT MODULE, NOTABLY FOR A VEHICLE

(71) Applicant: VALEO SYSTEMES THERMIQUES, Le Mesnil-Saint-Denis (FR)

(72) Inventors: Moussa Nacer-Bey, Le Mesnil-Saint-Denis (FR); Kamel Azzouz, Le Mesnil-Saint-Denis (FR); Sebastien Garnier, Le Mesnil-Saint-Denis (FR); Julien Tissot, Le Mesnil-Saint-Denis (FR)

(73) Assignee: VALEO SYSTEMES THERMIQUES, Le Mesnil-Saint-Denis (FR)

(21) Appl. No.: 18/872,274

(22) PCT Filed: May 31, 2023
(86) PCT No.: PCT/EP2023/064489

§ 371 Date: Dec. 6, 2024

(30) Foreign Application Priority Data
Jun. 9, 2022 (FR) FR2205540

(51) Int. Cl. F25B 41/40; F25B 39/04

(52) U.S. Cl. CPC F25B 41/40; F25B 39/04

(57) ABSTRACT

A fluid management module having a support including at least one channel for the flow of a refrigerant fluid. The support bearing at least one component with a fluidic function such as an expansion member or a refrigerant valve. The fluid management module includes at least one main two-fluid heat exchanger arranged to allow heat exchange between the refrigerant fluid and a heat-transfer fluid. The support is assembled with the heat exchanger so as to form at least one sealed connection for the refrigerant fluid flowing between the channel of the support and the main two-fluid heat exchanger.

The present invention relates to a fluid management module, in particular for a vehicle. The vehicle may be a land vehicle, marine vehicle or air vehicle. The fluid management module is intended in particular to be used in a cooling system, or more generally a thermal management system, comprising in particular a heat pump.

A major challenge at present for vehicles is the reduction of the bulk of the various items of equipment.

The invention proposes achieving the objective of reducing the bulk of a thermal management system.

The invention thus proposes a fluid management module, in particular for a vehicle, this module having a support comprising at least one channel for the flow of a refrigerant fluid, this support bearing at least one component with a fluidic function such as an expansion member or a refrigerant valve, this module further comprising at least one main two-fluid heat exchanger arranged to allow heat exchange between the refrigerant fluid and a heat-transfer fluid, the support being assembled with the heat exchanger so as to form at least one sealed connection for the refrigerant fluid flowing between the channel of the support and the main two-fluid heat exchanger, this sealed connection being formed by:
a fluidic connection flange fastened to the support and arranged to be assembled, in particular by screwing, brazing, welding or adhesive bonding, with a complementary connection flange of the main heat exchanger, or
a brazed junction between a fluidic connection end piece of the support, which end piece is at one end of the channel of the support, and a fluidic connection zone of the main heat exchanger.

“Fluidic function” is understood to mean a function that contributes to the operation of the module, which is for example selected to act on the flow of the heat-transfer fluid, or to measure a parameter associated with the fluid or its flow in the channels.

The invention makes it possible to obtain numerous advantages.

The invention makes it possible to replace hoses that are usually used with the support, while at the same time ensuring mechanical retention of the components with a fluidic function on the support. These fluidic connections are produced directly by channels of the support.

The support allows the components to be grouped together in a compact manner.

Thus, the support performs a plurality of roles, namely at least one structural role, since it can bear components, and a functional role, and this makes it possible to have a compact module with a number of parts that can be limited.

The invention makes it possible in particular to have a grouping of a plurality of components of a refrigerant circuit, in an optimal manner.

The invention thus makes it possible to reduce costs, since the invention makes it possible to dispense with numerous ducts for connecting the components.

In addition, it is possible, as will be seen below, to use the support as constituent element of a valve, for example. This makes it possible to achieve great compactness of the module.

The invention thus makes it possible to reduce the space occupied by the components, and this makes it possible to reduce the overall bulk of the cooling module. In the case of a heat pump, for example, the invention makes it possible to reduce the bulk of all of the components thereof, in particular of the various fluid circuits.

According to one of the aspects of the invention, the module comprises two main two-fluid heat exchangers, and the support is connected to the two heat exchangers so as to allow circulation of refrigerant fluid between the support and these exchangers.

According to one of the aspects of the invention, the two main exchangers are placed side by side. These exchangers are, for example, of substantially rectangular perimeter and they are placed such that their long sides are side by side.

According to one of the aspects of the invention, one of the exchangers is a low-pressure exchanger forming a refrigerant fluid/heat-transfer fluid cooler, and the other of the exchangers is a high-pressure exchanger forming a refrigerant fluid/heat-transfer fluid condenser.

According to one of the aspects of the invention, these main exchangers each comprise a stack of cooling plates.

According to one of the aspects of the invention, the high-pressure main heat exchanger is fluidically connected to a loop for circulation of the refrigerant fluid of the support that is intended for the circulation of the refrigerant fluid at high pressure.

According to one of the aspects of the invention, the low-pressure main heat exchanger is fluidically connected to a loop for circulation of the refrigerant fluid of the support that is intended for the circulation of the refrigerant fluid at low pressure.

According to one of the aspects of the invention, the channels of the low-pressure loop and high-pressure loop extend in one and the same plane of the support.

According to one of the aspects of the invention, these main exchangers are fluidically connected to an internal exchanger arranged to allow heat exchange between the refrigerant fluid circulating at high pressure and the refrigerant fluid circulating at low pressure.

The internal exchanger makes it possible to optimize the thermodynamic properties of the refrigerant fluid.

According to one of the aspects of the invention, this internal exchanger is placed against a base of the two main exchangers.

According to one of the aspects of the invention, the support is placed facing faces, referred to as upper faces, of the main heat exchangers.

According to one of the aspects of the invention, these upper faces are on the opposite side from the internal exchanger, which faces faces, referred to as lower faces, of the main heat exchangers.

According to one of the aspects of the invention, the support comprises a first plate and a second plate that are assembled with one another so as to define the channel, these plates being joined and forming together a circumference of the channel.

According to one of the aspects of the invention, the channel is formed by a first cavity of the first plate and/or a second cavity of the second plate.

According to one of the aspects of the invention, the plates are assembled with each other by welding or by adhesive bonding or brazing.

In the case of a brazed junction, the first plate is in particular brazed to the main heat exchanger at the location of the fluidic connection end piece of the support, and the second plate is in particular welded to the first plate.

According to one of the aspects of the invention, the fluidic connection end piece of the support is made in one piece with the first plate.

According to one of the aspects of the invention, the fluidic connection end piece of the support has a substantially frustoconical shape.

According to one of the aspects of the invention, the brazed zone is on an apex of this fluidic connection end piece of the support.

According to one of the aspects of the invention, the first plate and/or the second plate comprise sites that are able to receive one or more elements selected from: a valve, an expansion member, in particular an electronic expansion valve (called EXV for short) or a thermostatic expansion valve (called TXV for short), a flange, a temperature sensor, a pressure sensor, a temperature and pressure sensor.

According to one of the aspects of the invention, the support is placed facing only a part of the upper faces of the main exchangers, namely when the module is observed along an axis perpendicular to the upper faces, which are preferably generally flat, certain zones of these upper faces of the main exchangers are left uncovered, not covered by the support.

According to one of the aspects of the invention, these zones left uncovered receive one or more pipes of the main exchangers, which pipes are arranged to be connected to a heat-transfer fluid circuit.

According to one of the aspects of the invention, these pipes extend perpendicular to the upper faces of the exchangers.

Thus, the connectors for the heat-transfer fluid, which are formed in particular by rigid pipes, are disposed on the side of the support, and not on a side opposite the support.

The invention thus makes it possible to have the refrigerant fluid connections and those of the heat-transfer fluid on the same side of the exchangers, and this can make the assembly more compact.

According to one of the aspects of the invention, the first plate of the support is at a non-zero distance from the upper faces of the main exchangers, outside the brazed junction or the connection flange.

In the case of a brazed junction, the first plate comprises in particular an end piece provided at its apex with an opening for the passage of refrigerant fluid, this end piece being brazed to one of the main heat exchangers.

According to one of the aspects of the invention, this end piece, which is for example of frustoconical shape, extends into a housing of the heat exchanger, and the end piece is brazed to a surface at the bottom of this housing, while at the same time leaving the refrigerant fluid channels internal to the exchanger clear.

According to one of the aspects of the invention, at least one temperature/pressure sensor is inserted into the first plate and/or the second plate.

According to one of the aspects of the invention, the sensor is borne by a baseplate, in particular of round, square or rectangular cross section, this baseplate comprising a portion of the channel of the support.

According to one of the aspects of the invention, the support, which is in particular formed by two assembled plates, is mounted on said at least one, high-pressure or low-pressure, exchanger.

According to one of the aspects of the invention, the support, which is in particular formed by two assembled plates, is mounted on two exchangers, which are in particular selected from the low-pressure cooler, the high-pressure condenser and the internal exchanger.

According to one of the aspects of the invention, the low-pressure cooler (also called “chiller”), the high-pressure condenser and the internal exchanger form an assembly with preassembled exchangers.

“Refrigerant fluid at high pressure” is understood to mean a refrigerant fluid at a pressure in the region of 20 bar, and “refrigerant fluid at low pressure” at a pressure of 3 bar.

According to one of the aspects of the invention, the support is arranged to receive the refrigerant fluid at a pressure of between 3 and 20 bar.

According to one of the aspects of the invention, the support has no pump or 3-way or 4-way valve.

According to one of the aspects of the invention, the support, which is in particular formed by the first and second plates, comprises a passage for receiving a fluidic connection member, in particular a pipe, for the heat-transfer fluid.

According to one of the aspects of the invention, this passage is a hole that passes through the two assembled plates.

According to one of the aspects of the invention, the main exchangers each have a heat-transfer fluid inlet pipe and a heat-transfer fluid outlet pipe.

According to one of the aspects of the invention, for one of the main exchangers, one of the pipes passes through the through-hole of the support and the other of the pipes extends outside the support, without passing therethrough.

According to one of the aspects of the invention, the module comprises a compressor for the refrigerant fluid.

According to one of the aspects of the invention, the module comprises a bottle, in particular a desiccant bottle, configured to contain the refrigerant fluid at high pressure and to capture the moisture from the refrigerant fluid that passes through it.

According to another aspect of the invention, the module comprises an accumulator, configured to contain refrigerant fluid at low pressure.

According to one of the aspects of the invention, the one or more fluidic connection flanges are fastened to the support by brazing or welding or adhesive bonding.

According to one of the aspects of the invention, the heat-transfer fluid is selected from: a dielectric fluid and a cooling fluid such as water, or a mixture of water and ethylene glycol.

According to one of the aspects of the invention, the refrigerant fluid is selected from the fluids R134a, R1234yf or R744.

A further subject of the invention is a two-fluid circuit of a heat pump, having a module as mentioned above.

Within the context of a heat pump, the invention makes it possible to make all of the components of the module more compact, these components being able to belong to a refrigerant circuit and to a heat-transfer fluid circuit of the heat pump.

A further subject of the invention is a method for manufacturing a module as described above, with a step consisting in brazing, in particular in a furnace, the first plate to the heat exchanger and then a step consisting in welding the second plate to the first plate.

Further features and advantages of the invention will become more clearly apparent upon reading the following description, which is given by way of illustrative and non-limiting example, and the appended drawings, in which:

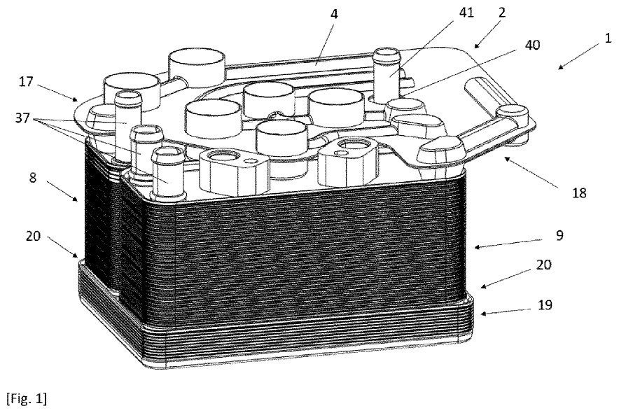

FIG. 1 schematically and partially illustrates, in perspective, a module according to one implementation example of the invention,

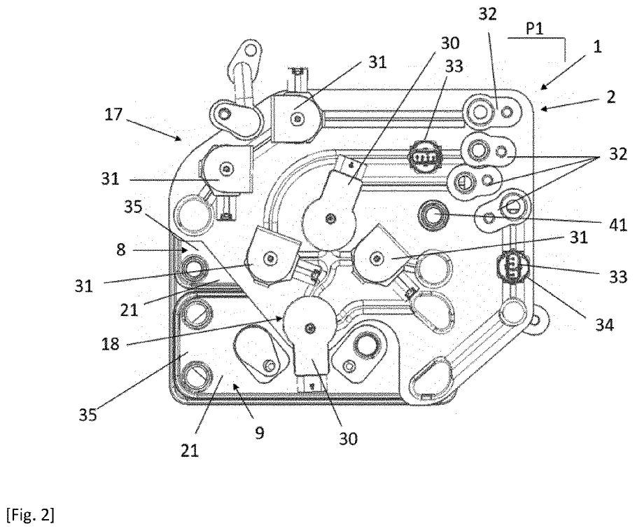

FIG. 2 schematically and partially illustrates, in a view from above, the module FIG. 1,

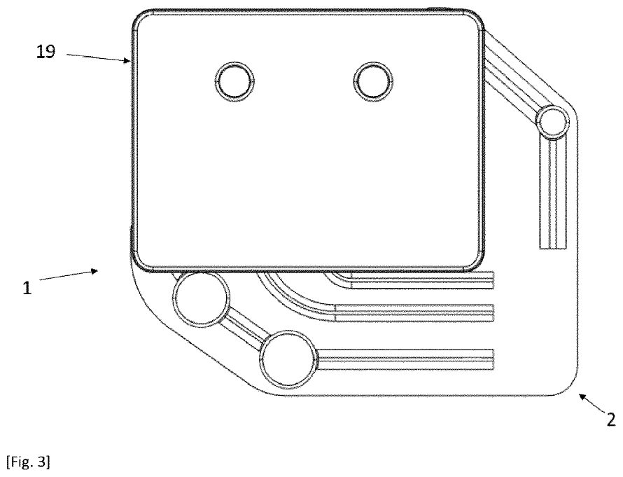

FIG. 3 schematically and partially illustrates, in a view from below, the module according to the view in FIG. 1,

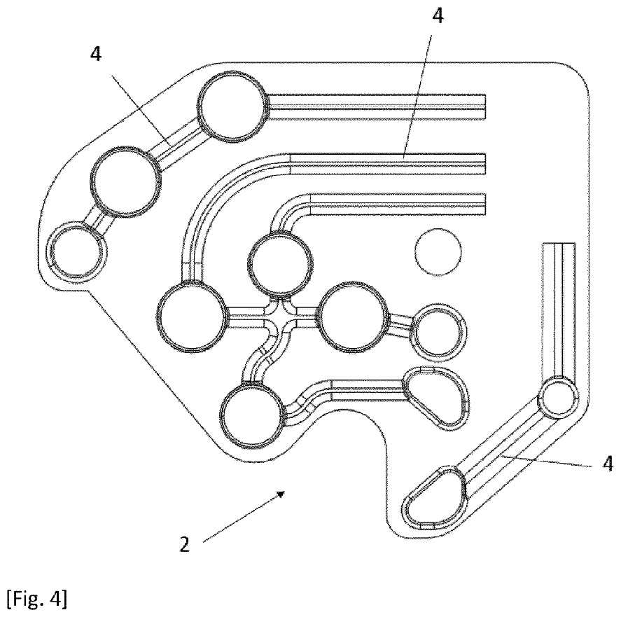

FIG. 4 schematically and partially illustrates, in a view from below, the support of the module in FIG. 1, without the components,

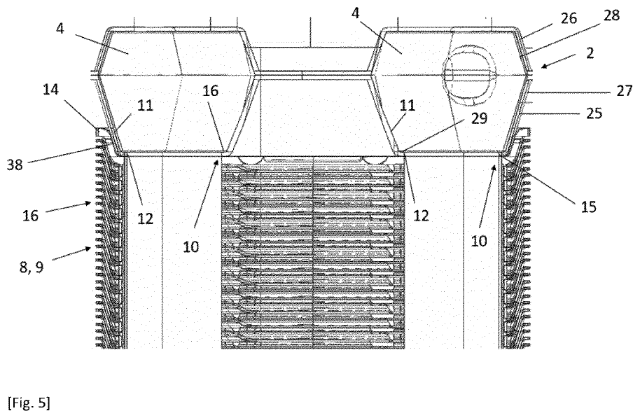

FIG. 5 schematically and partially illustrates, in cross section, a detail of the module in FIG. 1,

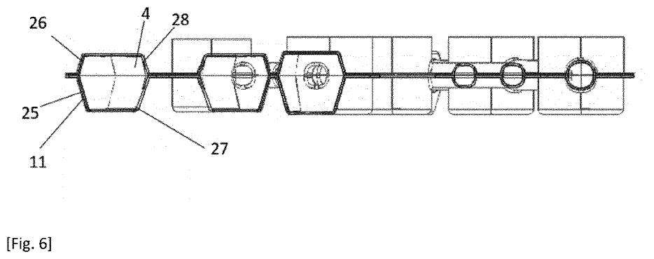

FIG. 6 schematically and partially illustrates, in cross section, the support of the module in FIG. 1,

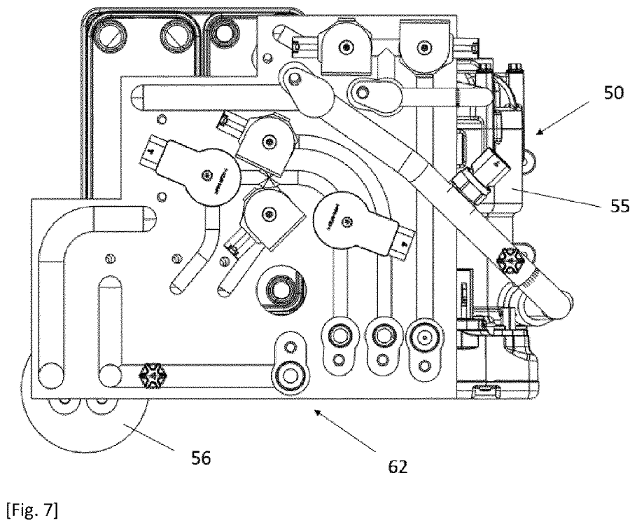

FIG. 7 schematically and partially illustrates, in a view from above, a module according to another implementation example of the invention,

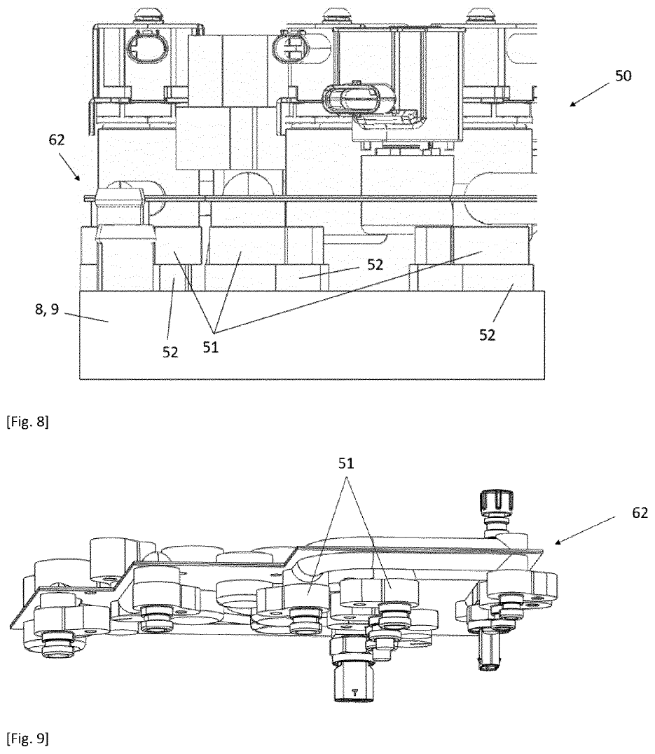

FIG. 8 schematically and partially illustrates, in a side view, the module in FIG. 1,

FIG. 9 schematically and partially illustrates, in perspective, the support of the module in FIG. 1.

FIGS. 1, 2 and 3 show a fluid management module 1 according to one implementation example of the invention, which module is intended to be used in a heat pump system on board a vehicle.

This module 1 is integrated in a heat-transfer fluid circuit, which can be a water circuit of the heat pump, and a refrigerant fluid circuit of the heat pump, in order to allow heat exchanges between the heat-transfer fluid and the refrigerant fluid.

The heat pump will not be described in greater detail, since it is known from the prior art. The invention can be adapted to a large number of types of cooling circuit, insofar as the various components can be selected to carry out the various expected functions.

The fluid management module 1 has a support 2 comprising a plurality of channels 4 for the flow of a refrigerant fluid.

The refrigerant fluid is selected from the fluids R134a, R1234yf or R744.

This support 2 bears components with a fluidic function, as will be seen below.

The module 1 further comprises two main two-fluid heat exchangers 8 and 9 arranged to allow heat exchange between the refrigerant fluid and a heat-transfer fluid.

The support 2 is assembled with the heat exchangers 8 and 9 so as to form sealed connections 10 for the refrigerant fluid flowing between the channels 4 of the support 2 and the main two-fluid heat exchangers 8 and 9.

In the example described, as can be seen more clearly in FIG. 5, each of these sealed connections 10 is formed by a brazed junction between a fluidic connection end piece 11 of the support 2, which end piece is at one end of the channel 4 of the support, and a fluidic connection zone 12 of the main heat exchanger 8, 9.

The connection zone 12 on the main heat exchanger 8, 9 is formed by an annular zone 15 on the outer plate 14 of the stack 16 of plates of this exchanger.

In the example described, the support 2 is connected to the two heat exchangers 8 and 9 so as to allow circulation of refrigerant fluid between the support 2 and these exchangers 8 and 9.

These two main exchangers 8 and 9 are placed side by side. These exchangers 8 and 9 are of substantially rectangular perimeter and they are placed such that their long sides are side by side.

One of the exchangers is a low-pressure exchanger 8 forming a refrigerant fluid/heat-transfer fluid cooler, and the other of the exchangers is a high-pressure exchanger 9 forming a refrigerant fluid/heat-transfer fluid condenser.

These main exchangers 8 and 9 each comprise a stack 16 of cooling plates.

The low-pressure main heat exchanger 8 is fluidically connected to a loop 17 for circulation of the refrigerant fluid of the support that is intended for the circulation of the refrigerant fluid at low pressure.

The high-pressure main heat exchanger 9 is fluidically connected to a loop 18 for circulation of the refrigerant fluid of the support that is intended for the circulation of the refrigerant fluid at high pressure.

The channels 4 of the low-pressure loop 17 and high-pressure loop 18 extend in one and the same plane P1 of the support 2, as illustrated in FIG. 2 for example.

These main exchangers 8 and 9 are fluidically connected to an internal exchanger 19 arranged to allow heat exchange between the refrigerant fluid circulating at high pressure and the refrigerant fluid circulating at low pressure.

The internal exchanger 19 makes it possible to optimize the thermodynamic properties of the refrigerant fluid.

The internal exchanger 19 is placed against a base 20 of the two main exchangers 8 and 9, these bases 20 being on a side of the exchangers that is opposite the support 2.

The support 2 is placed facing faces 21, referred to as upper faces, of the main heat exchangers 8 and 9.

These upper faces 21 are on the opposite side from the internal exchanger 19, which faces lower faces or bases 20 of the main heat exchangers 8 and 9.

The support 2 comprises a first plate 25 and a second plate 26 that are assembled with one another so as to define the channels 4, these plates 25 and 26 being joined and forming together a circumference of each channel 4.

Each channel 4 is formed by a first cavity 27 of the first plate 25 and a second cavity 28 of the second plate 26, as illustrated in FIGS. 5 and 6.

The plates 25 and 26 are assembled with each other by welding or by adhesive bonding or brazing.

In the case described of a brazed junction, the first plate 25 is brazed to the main heat exchanger 8, 9 at the location of the fluidic connection end piece 11 of the support 2, and the second plate 26 is welded to the first plate 25.

The fluidic connection end piece 11 is made in one piece with the first plate 25, and has a substantially frustoconical shape.

The brazed zone on the end piece 11 is on an apex 29 of this end piece 11. This apex 29 is open so as to be able to communicate with the heat exchanger 8 or 9.

Thus, this end piece 11 extends into a housing 38 of the heat exchanger.

The second plate 26 comprises sites that are able to receive a plurality of elements, including:
four refrigerant valves 31, two valves forming part of the low-pressure loop and the other two forming part of the high-pressure loop,
two expansion members 30, each one being an electronic expansion valve (called EXV for short) or a thermostatic expansion valve (called TXV for short), associated with the two loops, respectively the low-pressure loop and the high-pressure loop,
refrigerant fluid inlet and outlet flanges 32,
a temperature sensor 33, a pressure sensor, a temperature and pressure sensor.

The fluidic connection flanges 32 are fastened to the support 2 by brazing or welding or adhesive bonding.

Temperature and/or pressure sensors 33 are inserted on the second plate 26.

Each sensor 33 is borne by a baseplate 34, in particular of round, square or rectangular cross section, this baseplate comprising an associated portion of the channel 4, as is visible in FIG. 2.

The support 2 is placed facing only a part of the upper faces 21 of the main exchangers 8, 9, namely when the module 1 is observed along an axis perpendicular to the upper faces 21, which are in this case generally flat, certain zones 35 of these upper faces of the main exchangers 8, 9 are left uncovered, not covered by the support 2.

These zones 35 left uncovered receive a plurality of pipes 37 of the main exchangers 8, 9, which pipes 37 are arranged to be connected to a heat-transfer fluid circuit.

These pipes 37 extend perpendicular to the upper faces 21 of the exchangers.

Thus, the connectors for the heat-transfer fluid, which are formed by rigid pipes 37, are disposed on the side of the support 2, and not on a side opposite the support 2. This opposite side of the exchangers 8, 9, which is left free, makes it possible to receive the internal exchanger 19.

The first plate 25 of the support 2 is at a non-zero distance from the upper faces 21 of the main exchangers, outside the brazed junctions.

The support 2 is mounted on the high-pressure and low-pressure exchangers simultaneously.

The low-pressure cooler 8 (also called “chiller”), the high-pressure condenser 9 and the internal exchanger 19 form an assembly with preassembled exchangers.

“Refrigerant fluid at high pressure” is understood to mean a refrigerant fluid at a pressure in the region of 20 bar, and “refrigerant fluid at low pressure” at a pressure of 3bar.

The support 2 comprises a passage 40 for receiving a fluidic connection member, in this case a rigid pipe 41, for the heat-transfer fluid.

This passage 40 is a circular hole that passes through the two assembled plates 25, 26.

For one of the main exchangers, in this case the exchanger 8, one 41 of the two pipes passes through the through-hole 40 of the support 2 and the other of the pipes 37 extends outside the support 2, without passing therethrough.

FIGS. 7 to 9 show a module 50 according to another implementation example of the invention, which differs from the module 1 described above mainly by the fluidic connections between the support 62 and the main exchangers 8, 9.

In the example in FIGS. 7 to 9, the support 62 is assembled with the heat exchangers 8, 9 so as to form sealed connections for the refrigerant fluid flowing between the channels 4 of the support 62 and the two-fluid heat exchangers 8, 9, these connections being formed by fluidic connection flanges 51 fastened to the support 62 and each arranged to be assembled, in particular by screwing, brazing, welding or adhesive bonding, with a complementary connection flange 52 of the main heat exchanger 8, 9.

These flanges 51 replace the frustoconical end pieces described in the preceding example.

The module 50 comprises a compressor 55 for the refrigerant fluid, and a bottle 56, in particular a desiccant bottle, configured to contain the refrigerant fluid at high pressure and to capture the moisture from the refrigerant fluid that passes through it, or accumulator, configured to contain refrigerant fluid at low pressure.

A part of the support 62 faces the compressor 55.

As in the preceding example, the support 62 comprises a passage 40 for receiving a fluidic connection member, in this case a rigid pipe, for the heat-transfer fluid.

The heat-transfer fluid is selected from a dielectric fluid and a cooling fluid such as water, a mixture of water and ethylene glycol.

1. A fluid management module for a vehicle, the fluid management module having a support comprising:
at least one channel for the low of a refrigerant fluid,
wherein the support bearing at least one component with a fluidic function such as an expansion member or a refrigerant valve,
at least one main two-fluid heat exchanger arranged to allow heat exchange between the refrigerant fluid and a heat-transfer fluid,
wherein the support is assembled with the at least one main two-fluid heat exchanger so as to form at least one sealed connection for the refrigerant fluid flowing between the channel of the support and the at least one main two-fluid heat exchanger,
wherein the at least one sealed connection is formed by:
a fluidic connection flange fastened to the support and arranged to be assembled, by screwing, brazing, welding or adhesive bonding, with a complementary connection flange of the at least one main two-fluid heat exchanger, or
a brazed junction between a fluidic connection end piece of the support, which end piece is at one end of the channel of the support, and a fluidic connection zone of the at least one main two-fluid heat exchanger.

2. The fluid management module as claimed in claim 1, comprising:
two main two-fluid heat exchangers,
wherein the support is connected to the two main two-fluid heat exchangers so as to allow circulation of the refrigerant fluid between the support and the two main two-fluid heat exchangers.

3. The fluid management module as claimed in claim 2, wherein one of the two main two-fluid heat exchangers is a low-pressure exchanger forming a refrigerant fluid/heat-transfer fluid cooler, and the other of the two main two-fluid heat exchangers is a high-pressure exchanger forming a refrigerant fluid/heat-transfer fluid condenser.

4. The fluid management module as claimed in claim 2, wherein the two main two-fluid heat exchangers are fluidically connected to an internal exchanger arranged to allow heat exchange between the refrigerant fluid circulating at high pressure and the refrigerant fluid circulating at low pressure.

5. The fluid management module as claimed in claim 4, wherein the internal exchanger is placed against a base of the two main two-fluid heat exchangers.

6. The fluid management module as claimed in claim 1,
wherein the support comprises a first plate and a second plate that are assembled with one another so as to define the channel,
wherein the first plate and the second plate are joined and forming together a circumference of the channel.

7. The fluid management module as claimed in claim 6, wherein the first plate is brazed to the at least one main two-fluid heat exchanger at the location of the fluidic connection end piece of the support, and the second plate is welded to the first plate.

8. The fluid management module as claimed in claim 1, wherein a first plate and/or a second plate comprise sites that are able to receive one or more elements selected from: a valve, an expansion member, a flange, a temperature sensor, a pressure sensor, a temperature and a pressure sensor.

9. The fluid management module as claimed in claim 1,
wherein the support is formed by a first plate and a second plate,
wherein the support comprises a passage for receiving a fluidic connection member for the heat-transfer fluid.

10. A two-fluid circuit of a heat pump, having the fluid management module as claimed in claim 1.
